(19) United States
(12) Patent Application Publication
(10) Pub. No.: US 2005/0257026 A1
(43) Pub. Date: Nov. 17, 2005

(54) Bit serial processing element for a SIMD array processor

(76) Inventor: Woodrow L. Meeker, Orlando, FL (US)

Correspondence Address: CARL M. NAPOLITANO, PH.D.;ALLEN, DYER, DOPPELT, MILBRATH & GILCHRIST, P.A., 255 SOUTH ORANGE AVE., SUITE 1401, P.O. BOX 3791, ORLANDO, FL, 32802-3791, US

(21) Appl. No.: 11/120,549

(22) Filed: May 3, 2005

Related U.S. Application Data
(60) Provisional application No. 60/567,624, filed on May 3, 2004.

(51) Int. Cl. G06F 15/00

(52) U.S. Cl. 712/22; 712/13

(57) ABSTRACT

In an image processing system, computations on pixel data may be performed by an array of bit-serial processing elements (PEs). A bit-serial PE is implemented with minimal logic in order to provide the highest possible density of PEs constituting the array. Improvements to the PE architecture are achieved to enable operations to execute in fewer clock cycles. However, care is taken to minimize the additional logic required for improvements. The bit-serial nature of the PE is also maintained in order to promote the highest possible density of PEs in an array. PE improvements described herein include enhancements to improve performance for sum of absolute difference (SAD) operations, division, multiplication, and transform (e.g. FFT) shuffle steps.

### CROSS-REFERENCE TO RELATED APPLICATIONS

This application claims the benefit of U.S. Provisional Application No. 60/567,624, filed May 3, 2004, the disclosure of which is hereby incorporated herein in its entirety by reference.

### FIELD OF THE INVENTION

This invention relates to SIMD parallel processing, and in particular, to bit serial processing elements.

### BACKGROUND OF THE INVENTION

Parallel processing architectures, employing the highest degrees of parallelism, are those following the Single Instruction Multiple Data (SIMD) approach and employing the simplest feasible Processing Element (PE) structure: a single-bit arithmetic processor. While each PE has very low processing throughput, the simplicity of the PE logic supports the construction of processor arrays with a very large number of PEs. Very high processing throughput is achieved by the combination of such a large number of PEs into SIMD processor arrays.

A variant of the bit-serial SIMD architecture is one for which the PEs are connected as a 2-D mesh, with each PE communicating with its 4 neighbors to the immediate north, south, east and west in the array. This 2-d structure is well suited, though not limited to, processing of data that has a 2-d structure, such as image pixel data.

### SUMMARY OF THE INVENTION

The present invention in one aspect provides a processing array comprising a plurality of processing elements, wherein
each of the processing elements performs the same operation simultaneously in response to an instruction that is provided to all processing elements;
each processing element is configured to perform arithmetic operations on m-bit data values, propagating one of a carry and borrow results from each operation, and accepting a signal comprising one of a carry and borrow input to the operation;
the selection of the carry and borrow values to propagate is performed individually for each processing element by a mask value local to that processing element.

In another aspect, the present invention provides a processing array comprising a plurality of processing elements, wherein
each of the processing elements performs the same operation simultaneously in response to an instruction that is provided to all processing elements;
the processing elements are interconnected to form a 2-dimensional mesh wherein each processing element is coupled to its 4 nearest neighbors to the north, south, east, and west;
each processing element provides an NS register configured to hold data and to convey the data to the north neighbor while receiving data from the south neighbor in response to an instruction specifying a north shift, and to convey the data to the south neighbor while receiving data from the north neighbor in response to an instruction specifying a south shift;
each processing element provides an EW register configured to hold data and to convey the data to the east neighbor while receiving data from the west neighbor in response to an instruction specifying an east shift, and to convey the data to the west neighbor while receiving data from the east neighbor in response to an instruction specifying a west shift;
a simultaneous shift of data in opposite directions along one of the east-west and north-south axes is performed by using the NS and EW registers respectively to convey and receive data in opposite directions.

In yet another aspect, the present invention provides a processing array comprising a plurality of processing elements, wherein
each processing element comprises means adapted to perform a multiply of an m-bit multiplier by an n-bit multiplicand within a single pass, said pass comprising n cycles, each cycle comprising a load of a multiplicand bit to a multiplicand register, a load of an accumulator bit to an accumulator register, generation of a partial product value, and the storage of a computed accumulator bit to a memory;
said partial product comprising m+1 bits, the least significant bit of which is conveyed as the computed accumulator bit, and the value represented by the remaining m bits is stored in an m-bit partial product register;
said partial product being computed by summing the accumulator bit, the registered partial product, and the m-bit product of the multiplicand bit and an m-bit multiplier.

Further details of different aspects and advantages of the embodiments of the invention will be revealed in the following description along with the accompanying drawings.

### BRIEF DESCRIPTION OF THE DRAWINGS

In the accompanying drawings:

FIG. 1 is a schematic diagram illustrating an exemplary processing element (PE).

FIG. 2 is a graphical representation of an array of processing elements.

FIG. 3 is a schematic diagram illustrating a PE array composed of processing element groups (PEGs).

FIG. 4 is a schematic diagram of a PEG.

FIG. 5 is a schematic diagram of a simd array processor.

FIG. 6 is a table showing the components (command fields) of a PE instruction word.

FIG. 7 is a detailed schematic diagram of a processing element as configured for normal operations.

FIG. 8 is a truth table showing the normal operation of the PE ALU.

FIG. 9 is a table showing the PE command definitions.

FIG. 10 is a table showing the PE ALU command definitions.

FIG. 11 is a table showing the definition of the Bw_cy (borrow/carry) signal.

FIG. 12 is a table showing the definitions of the NS and EW commands when bi-directional shifting is selected.

FIG. 13 is a table showing the definitions of signals used for bi-directional shifting.

FIG. 14 is a graphical illustration showing the pattern of operand data movement during a multiply operation.

FIG. 15 is a detailed schematic diagram of a Processing Element as configured for multiply operations.

FIG. 16 is a table showing the definitions of AL, BL and D commands during multiply operations.

FIG. 17 is a table showing the definitions of signals used during multiply operations.

FIG. 18 is a graphical representation of a multiply operation using the disclosed multiplication technique.

FIG. 19 is a table showing the sequence of commands required for an exemplary multiplication operation.

### DETAILED DESCRIPTION OF THE PREFERRED EMBODIMENTS

Embodiments of the invention may be part of a parallel processor used primarily for processing pixel data. The processor comprises an array of processing elements (PEs), sequence control logic, and pixel input/output logic. The architecture may include single instruction multiple data (SIMD), wherein a single instruction stream controls execution by all of the PEs, and all PEs execute each instruction simultaneously. The array of PEs will be referred to as the PE array and the overall parallel processor as the PE array processor. Although in the exemplary embodiments particular dimensions of the SIMD array are given, it should be obvious to those skilled in the art that the scope of the invention is not limited to these numbers and it applies to any M×N PE array.

The PE array is a mesh-connected array of PEs. Each PE 100 comprises memory, registers and computation logic for processing 1-bit data. In an exemplary embodiment of the invention, the array comprises 48 rows and 64 columns of PEs. The PE array constitutes the majority of the SIMD array processor logic, and performs nearly all of the pixel data computations.

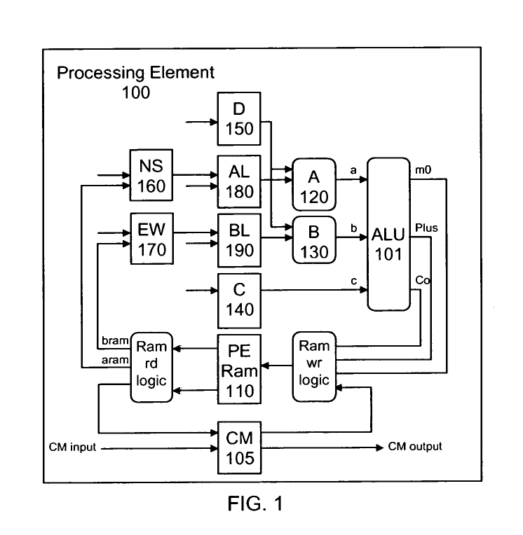

The exemplary PE 100 of FIG. 1 comprises a RAM 110, ALU 101, logic blocks A 120, B 130, and registers C 140, D 150, NS 160, EW 170, AL 180, BL 190, and CM 105 for processing 1-bit data. The ALU 101 may be as simple as a full adder circuit, or, in more elaborate examples, may include more advanced arithmetic capabilities. The set of registers loads pixel data from the PE RAM 110 and holds it for processing by the ALU 101. The CM register provides for input and output of pixel data.

The PE RAM 110 is effectively 1-bit wide for each PE 100 and stores pixel data for processing by the PE 100. Multi-bit pixel values are represented by multiple bits stored in the PE RAM 110. Operations on multi-bit operands are performed by processing the corresponding bits of the operand pixels in turn. In the exemplary embodiment, the PE RAM 110 provides 2 reads and 1 write per cycle. Other embodiments may employ other multi-access approaches or may provide a single read or write access per cycle.

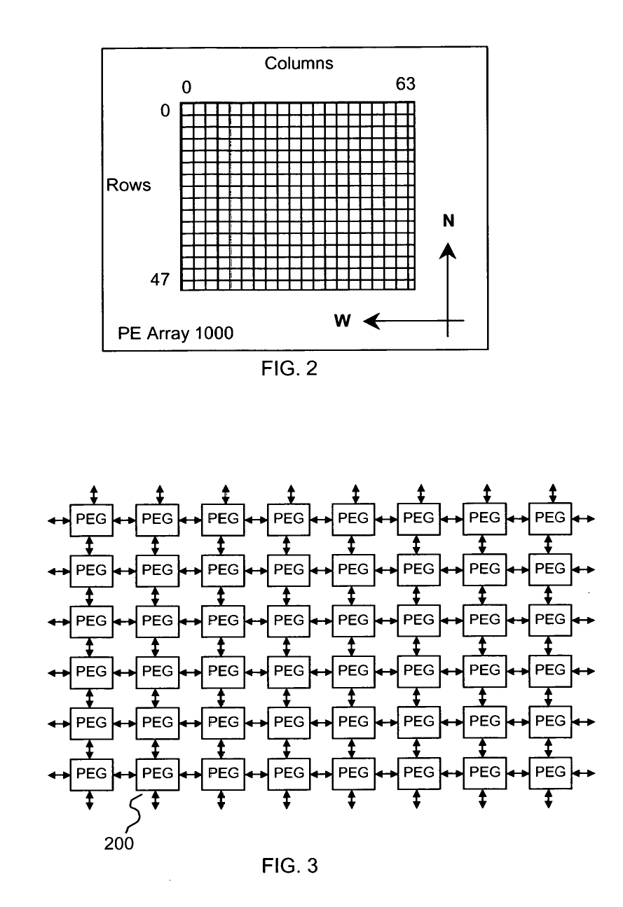

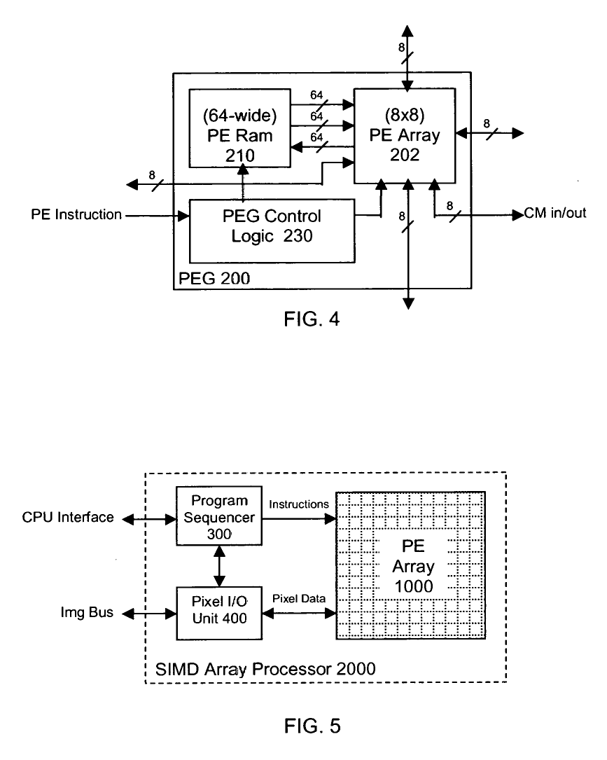

An exemplary PE array 1000 comprises 48 rows and 64 columns of PEs as shown in FIG. 2. Pixel numbering proceeds from 0,0 at the northwest corner of the array to 47,63 at the southeast corner.

The PEs of the exemplary SIMD array processor 2000 are arranged in a 2-d grid as shown in FIG. 2. Each PE communicates with its 4 nearest neighbors, specifically the PEs directly to the north, south, east and west of it in the array. The PE-to-PE communication paths of the exemplary embodiment are 1-bit in width and bidirectional.

During processing, all PEs of the array perform each operation step simultaneously. Every read or write of an operand bit, every movement of a bit among PE registers, every ALU output is performed simultaneously by every PE of the array. In describing this pattern of operation, it is useful to think of corresponding image bits collectively. An array-sized collection of corresponding image bits is referred to as a “bit plane”. From the point of view of the (serial) instruction stream, SIMD array operations are modeled as bit plane operations.

Each instruction in this exemplary embodiment comprises commands to direct the flow or processing of bit planes. A single instruction may contain multiple command fields including 1 for each register resource, 1 for the PE RAM write port, and an additional field to control processing by the ALU 101. This approach is a conventional micro-instruction implementation for an array instruction that provides array control for a single cycle of processing.

The exemplary PE array 1000 is hierarchical in implementation, with PEs partitioned into PE groups (PEGs). Each PEG 200 comprises 64 PEs representing an 8×8 array segment in this particular example of the invention. The 48×64 PE array 1000 is therefore implemented by 6 rows of PEGs, each row having 8 PEGs. Each PEG 200 is coupled to its neighboring PEGs such that PE-to-PE communication is provided across PEG boundaries. This coupling is seamless so that, from the viewpoint of bit plane operations, the PEG partitioning is not apparent.

The exemplary PEG 200 comprises a 64-bit wide multi-access PE RAM 210, PEG control logic 230, and the register and computation logic making up the 64 Pes in PE array 202. Each bit slice of the PE RAM 210 is coupled to one of the 64 PEs, providing an effective 1-bit wide PE RAM for each PE in PE array 202.

In addition to communication with north, south, east and west neighbors, each of the exemplary PEGs includes an 8-bit input and output path for moving pixel data in and out of the PE array 202. The CM register plane provides handling of bit plane data during the input and output. Data is moved in and out of the PE array 202 in bit plane form.

The PE array described above provides the computation logic for performing operations on pixel data. To perform these operations, the PE array requires a source of instructions and support for moving pixel data in and out of the array.

An exemplary SIMD array processor 2000 is shown in FIG. 5. The SIMD array processor 2000 includes a program sequencer 300 to provide the stream of instructions to the PE array 1000. A pixel I/O unit 400 is also provided for the purpose of controlling the movement of pixel data in and out of the PE array 1000. Collectively, these units comprise a SIMD array processor 2000.

The SIMD array processor 2000 may be employed to perform algorithms on array-sized image segments. This processor might be implemented on an integrated circuit device or as part of a larger system on a single device. In either implementation, the SIMD array processor 2000 is subordinate to a system control processor, referred to herein as the “CPU”. An interface between the SIMD array processor 2000 and the CPU provides for initialization and control of the exemplary SIMD array processor 2000 by the CPU.

The pixel I/O unit 400 provides control for moving pixel data between the PE array 1000 and external storage via the Img Bus. The movement of pixel data is performed concurrently with PE Array computations, thereby providing greater throughput for processing of pixel data.. The pixel I/O unit 400 performs a conversion of image data between pixel form and bit plane form. Img Bus data is in pixel form and PE Array data is in bit plane form, and the conversion of data between these forms is performed by the pixel I/O unit 400 as part of the i/o process.

The SIMD array processor 2000 processes image data in array-sized segments known as “subframes”. In a typical scenario, the image frame to be processed is much larger than the dimensions of the PE array 1000. Processing of the image frame is accomplished by processing subframe image segments in turn until the image frame is fully processed.

A detailed description of an exemplary improved PE implementation is provided herein. A baseline PE architecture, such as that introduced earlier is described. Improvements to this architecture are described in detail and include 1
a carry-borrow signal that is selectable on a PE basis,
a bi-directional shift capability, and,
an enhanced multiply capability.

The PE 100 comprises 7 registers, associated signal selection logic, computation logic, and 3 memory data ports. The input memory data ports are designated aram, bram and the output memory port is the wram port. Each PE communicates with its 4 neighbors through the NI/NO, SI/SO, EI/EO and WI/WO shift plane inputs and outputs.

Each of the register inputs is selected by a multiplexor, namely, C mux 144, D mux 154, NS mux 164, EW mux 174, AL mux 184, BL mux 194. The wram output is selected by the RAM mux 114.

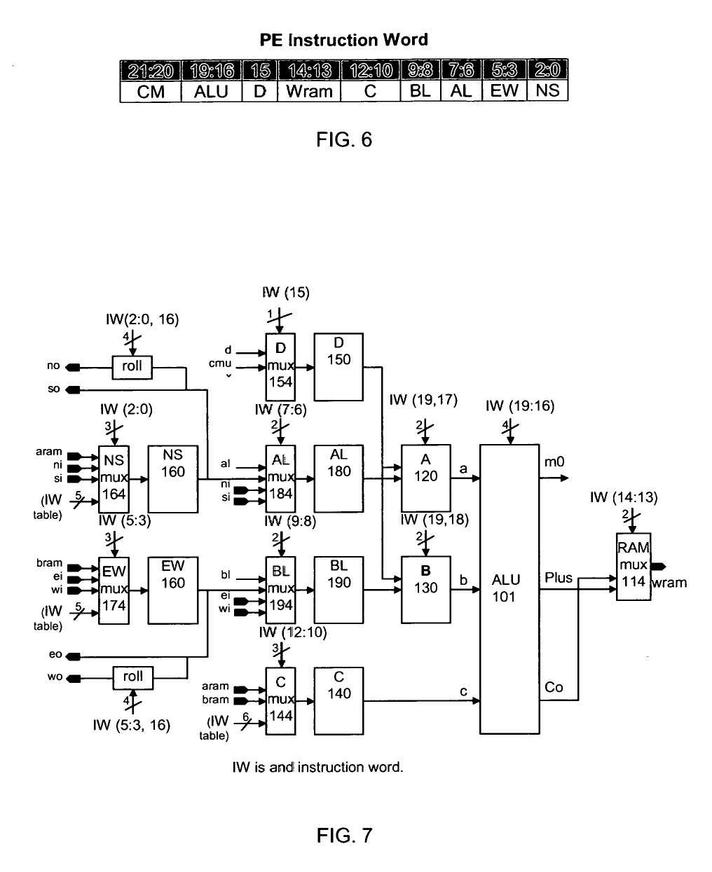

Operation of the PE 100 is controlled on a clock-to-clock basis by a PE instruction word as shown in FIG. 6. The instruction word comprises command fields, each of which (except Alu_cmd) provides a select value to one of the register (or wram) multiplexors. The ALU 101 command field (Alu_cmd) controls operation of the computation logic by defining the manner in which some PE signals are generated.

The operation of the PE 100 may be described in terms of two modes of operation: normal operation and multiplication. Normal operation is indicated by an Alu_cmd of 0XXX or 1001. Multiplication is indicated by an Alu_cmd of 1XX0.

A diagram of the PE 100 operating in the normal mode is shown in FIG. 7. The CM 105 register is not shown since it is not involved in computation.

During a normal PE operation, each bit of the first source operand is loaded to the NS 160 and AL 180 registers, respectively. From the AL 180 register, the data is provided to the ALU 101 via the ‘a’ input. Depending on the Alu_cmd, the data may or may not be combined with the D 150 register value by the A 120 mask logic to produce the ‘a’ value.

Similarly, each bit of the second source operand is loaded to EW 170 and BL 190 and provided to the ALU 101 via the ‘b’ input. A separate Alu_cmd signal determines whether masking is applied by the B 130 mask logic.

For a normal operation, the C 140 register may be initialized to a desired start value. During the course of the operation, the ALU 101 carry or borrow result may be propagated to C 140 register via the CO (ALU output) signal. In this manner, multi-bit ADD and SUBTRACT operations may be performed.

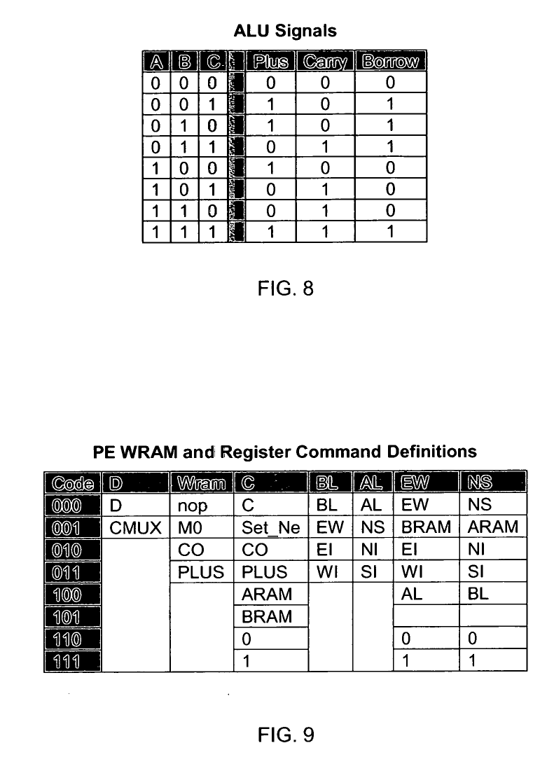

Each destination operand bit is written to PE RAM 110 via the wram output signal. This signal may be a selected ALU output such as “Plus” or “Co” (FIG. 7) depending on the operation to be performed. For a normal operation, the ALU 101 is defined as a full adder circuit. The Plus and Co signals represent the sum and carry (or borrow) outputs of a full adder (see FIG. 8).

The D 150 register may be loaded with a mask value where operand masking is desired. Masking allows operations to be performed conditionally. Conditional ADD, SUBTRACT and FORK (conditional assignment) are supported through operand masking.

The Wram and PE register command field definitions are shown in FIG. 9. Each of these command fields provides a select code for a multiplexor. The multiplexor in turn selects from a number of input values for the register (or Wram port).

The NS 160 and EW 170 registers are loaded with first and second source operand data, respectively. Where an operand is a scalar, a 0 or 1 may be loaded to either register directly. Where an operand is a subframe image, the Aram or Bram value is loaded.

NS 160 and EW 170 may also be used for bit plane shifts. For example, if NS 160 loads the NI value, a shift from the north (i.e. to the south) occurs. If NS 160 loads SI, a shift from the south occurs. Likewise EW 170 may shift from the east by loading EI, or shift from the west by loading WI.

The operand bits are propagated to the AL 180 and BL 190 registers from NS 160 and EW 170 respectively (e.g. AL=NS, BL=EW). AL 180 and BL 190 may also load shifted NS and EW values (e.g. AL=NI, BL=WI).

The C 140 register may be initialized with a scalar 0 or 1, or may be loaded from PE RAM 110 via Aram or Bram. Alternatively, the C 140 register can propagate a carry or borrow ALU output by loading Co. The D 150 register may be loaded with a new value by selecting the C mux 144 signal. The C mux 144 value loads the D 150 register from the output of the C multiplexor, i.e. the D 150 and C 140 registers load the same value during that cycle.

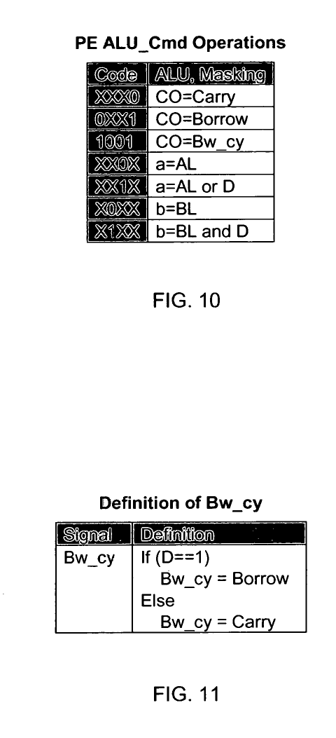

During a normal operation for which the Alu_cmd is 0XXX, the lowest 3 bits of Alu_cmd provide independent control of the Co, a and b values respectively (see FIG. 10). Alu_cmd[0] determines whether the Co is defined as a carry or borrow value. An active Alu_cmd[1] value causes the AL value to be OR-masked with the D value to produce the ALU ‘a’ input signal. An active Alu_cmd[2] value causes the BL value to be AND-masked with the D value to produce the ALU ‘b’ input signal.

When Alu_cmd is 1001, the Bw_cy signal is selected as the Co value. The Bw_cy signal is a borrow where the D 150 register is 0 and Carry where the D 150 register is 1. The use of Bw_cy allows each PE to determine whether to perform an ADD or SUBTRACT based on the local D value. Three uses for the Bw_cy feature will be shown. The first is to provide an absolute value operation, the second is to provide a faster sum of absolute differences (SAD) step, and the third is a method for performing a faster divide. Each of these applications use a borrow/carry Bw_cy to perform an Addsub function. The Addsub (A, B, M) may be described as:
_If (M)
   Return (A−B)
Else
   Return (A+B).

An absolute value (ABS) is currently performed by a sequence of NEGATE and FORK operations. However, the combination of operations requires twice the time of a single-pass operation and generates a temporary image for which space must be allocated. The Bw_cy signal enables a simple single-pass ABS function.

The improved ABS function is performed by loading the sign bit for the source operand to the D 150 register. An ADD is then performed with 0 as the first source operand and the ABS source operand (Src) as the second source operand. The Bw_cy signal is selected by the Alu_cmd and propagated to the C 140 register via the Co signal for each bit of the operation. The resulting operation is effectively as follows:
Dest=Addsub (0, Src, Src'sign)

It may be seen that, where a source pixel is negative, the Dest operand is the negative of that pixel, otherwise the Dest operand is the same value as the pixel.

A second use for the Bw_Cy signal is to perform a faster SAD step. For each step of the SAD, corresponding pixels (P1, P2) of two templates are compared. The magnitude of the difference of the two pixels is added to a running total (Sum). This SAD step comprises 3 operations as shown:
Tmp=P1−P2
Tmp=ABS(Tmp)
Sum=Sum+Tmp

The Bw_Cy signal may be used to reduce the number of operations from 3 to 2. The SUBTRACT of P1 and P2 is performed with the sign of the difference being propagated to the D register. Next, an Addsub of the difference with the Sum is performed. Therefore, where the difference is negative, the value is subtracted from the Sum and where the difference is positive, the value is added to the Sum. This is shown:
Tmp=P1−P2
D=Tmp'sign
Sum=Addsub (Sum, Tmp, Tmp'sign)

The loading of the Tmp'sign to D 150 can be incorporated into the subtraction operation so that it adds nothing to the execution time.

A third use for the Bw_cy signal is to perform a faster divide operation. For a bit-serial PE, the divide requires a number of passes equal to the number of quotient bits to be generated. Each pass generates a single quotient bit. For a typical PE, each pass requires a compare and a conditional subtraction:
Quotient[i]=Denominator<=Remainder[rmsb:i]
If (Quotient[i]==1)
   Remainder[rmsb:i]=Remainder[rmsb:i]−Denominator
(where rmsb is the Remainder operand size −1)

In the above method, the quotient bits (indexed by ‘i’) are generated in reverse order, that is the most significant bit is generated first and the least significant bit last. Each pass requires 2 operations on the Denominator operand. Therefore the overall time required for this operation is roughly 2*Q*D cycles (where Q is the Quotient size and D is the Denominator size).

The Bw_cy signal provides a means for performing one pass of an unsigned divide with a single Addsub operation. In this improved method, the Remainder value is allowed to be positive or negative as a result of the Addsub operation performed during each pass. The sign of the Remainder determines, for each pass, whether the Addsub will function as an Add or a Subtract. Where the Remainder is negative, an Add is performed; where the Remainder is positive, a Subtract is performed. Although the Remainder may change signs as the result of an Addsub, its magnitude will tend to approach 0 with each successive pass. For this division method, each pass comprises:
Quotient[i]=not Remainder'sign
Remainder[rmsb:i]=
Addsub(Remainder[rmsb:i], Denominator, Quotient[i])

In this method of division, the Quotient bits (indexed by ‘i’) are generated in reverse order. Each pass requires 1 (Addsub) operation on the Denominator. The overall time for this operation is therefore roughly Q*D cycles.

The divide technique described above may also be used to perform a faster modulus operation. The Remainder value at the end of the division is tested, and where it is less than 0, the Denominator is added to it providing the correct Remainder value for the division operation. (This correction step is not required if only the Quotient result is needed for the division operation.)

Each PE of the SIMD array is coupled to its 4 nearest neighbors for the purpose of shifting bit plane data. The NO (north output) signal of a PE, for example, is connected to the SI (south input) signal of the PE to the north. In this manner, the NO, SO, EO and WO outputs of each PE are connected to the SI, NI, WI and EI inputs of the 4 nearest neighbor PEs.

Where normal shifting is performed, the NS register plane of the PE array may shift north or south (not both). The EW register plane may shift east or west (not both). The NS and EW register planes are independent such that simultaneous north-south and east-west shifting of separate bit planes is readily performed.

For normal shifting, the NO and SO signals for a PE are set to the NS 160 register value while the EO and WO signals are set to the EW register value. A shift to the north is performed by loading the SI PE input to the NS 160 register, since the SI signal is coupled to the NO output of the PE to the south of each PE. The remaining shift directions are accommodated by loading the corresponding PE input to the NS 160 and EW 170 registers. The normal shift commands are shown in FIG. 9.

For some operations, simultaneous shifting of bit planes in opposite (rather than orthogonal) directions would be advantageous. One example of such an operation is the butterfly shuffle operations performed during an FFT. One step of a butterfly shuffle might involve a position exchange for two groups of 4 pixel values as shown:

| | | | | | | | | |
|---|---|---|---|---|---|---|---|---|
| p0 | p1 | p2 | p3 | p4 | p5 | p6 | p7 | // before exchange |
| p4 | p5 | p6 | p7 | p0 | p1 | p2 | p3 | // after exchange |

The pixels in this example might be arranged along a row or along a column. For row data, a bi-directional shift in the east-west direction would speed up the exchange by a factor of 2. The bi-directional shift required for such an exchange is a capability of the improved PE.

An improvement to the PE provides for shifting in opposite directions so that exchange patterns, such as the example above, may be implemented. Two configuration signals, Rx (row exchange) and Cx (column exchange) indicate whether an alternate shift configuration is active. The Rx and Cx signals are mutually exclusive; i.e. they cannot be simultaneously active. When neither is active, a normal shift configuration is indicated. The Rx and Cx configuration signals may be implemented in any manner convenient to the designer. For the exemplary PE array, Rx and Cx are registers that reside in each PEG 200. In this embodiment, Rx and Cx must have the same values for all PEGs in the array. That is, a single shift configuration is specified for the entire array.

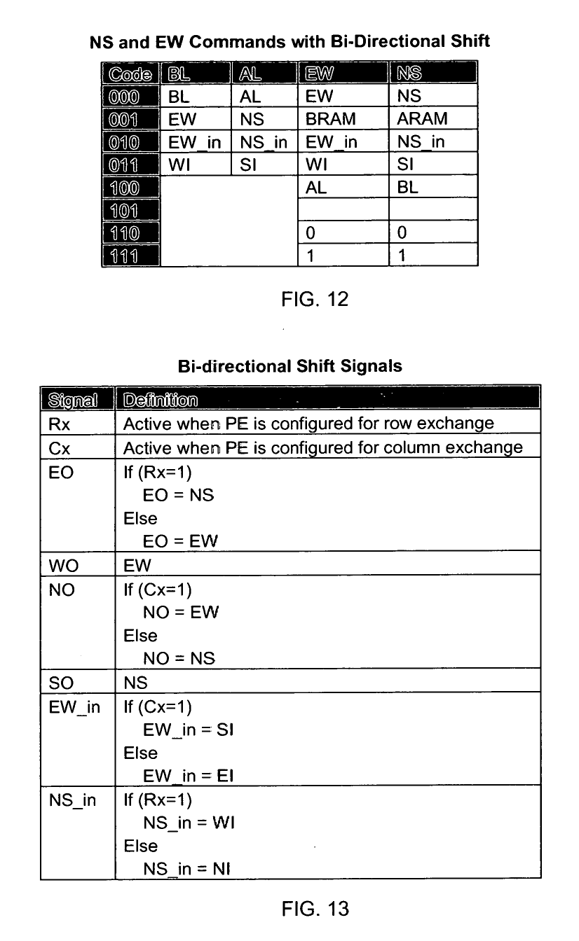

Bi-directional shifting is added to the PE instruction word through a simple change to the AL, BL, NS and EW commands. The EI and NI command selections are replaced by the EW_in and NS_in signals (see FIG. 12). When Rx and Cx are inactive, the EW_in and NS_in signals are defined to be EI and NI respectively. For this configuration, the commands of FIG. 12 are identical to those in FIG. 9.

When the Rx signal is active, a row exchange shift is performed by using NS/AL=NS_in and EW/BL=EI. These commands cause the EW plane to shift from the east and the NS plane to shift from the west. It may be seen from FIG. 13 that an active Rx causes the EO signal to be set to the NS value and the NS_in signal to be set to WI, causing a shift of the NS plane from the west.

When the Cx signal is active, a column exchange shift is performed by using EW/BL=EW_in and NS/AL=NI. These commands cause the NS plane to shift from the north and the EW plane to shift from the south. It may be seen from FIG. 13 that an active Cx causes the NO signal to be set to the EW value and the EW_in signal to be set to SI, causing a shift of the EW plane from the south.

A multiply of 2 multi-bit operands may be performed using the PE in its “normal” configuration. The multiply would be a multi-pass operation requiring m passes, each “pass” comprising an n-bit conditional add, where m is the number of bits in the multiplier and n is the number of bits in the multiplicand. For each pass, a successive bit of the multiplier is loaded to the D register. A conditional add of the multiplicand to the accumulated partial product (at the appropriate bit offset) is then performed. In this manner, a bit serial multiply is carried out in about m*n.

The bit serial multiply described above effectively multiplies the multiplicand by a single bit of the multiplier on each pass. One method for improving the bit serial multiply is to increase the number of multiplier bits applied on each pass. A method of doing this is described herein. This method is an improvement over earlier methods in that the number of PE registers required to support the method is reduced by 1.

The exemplary improved multiply provides multiplication of the multiplicand by 2 multiplier bits during each pass, requiring 6 PE registers for implementation. The same method might be extended to any number of multiplier bits (per pass) by adding appropriate adders (in addition to full adder 102 and full adder 103 in the exemplary embodiment shown in FIG. 15) to the ALU 101′ and with the addition of 2 PE registers for each additional multiplier bit accommodated.

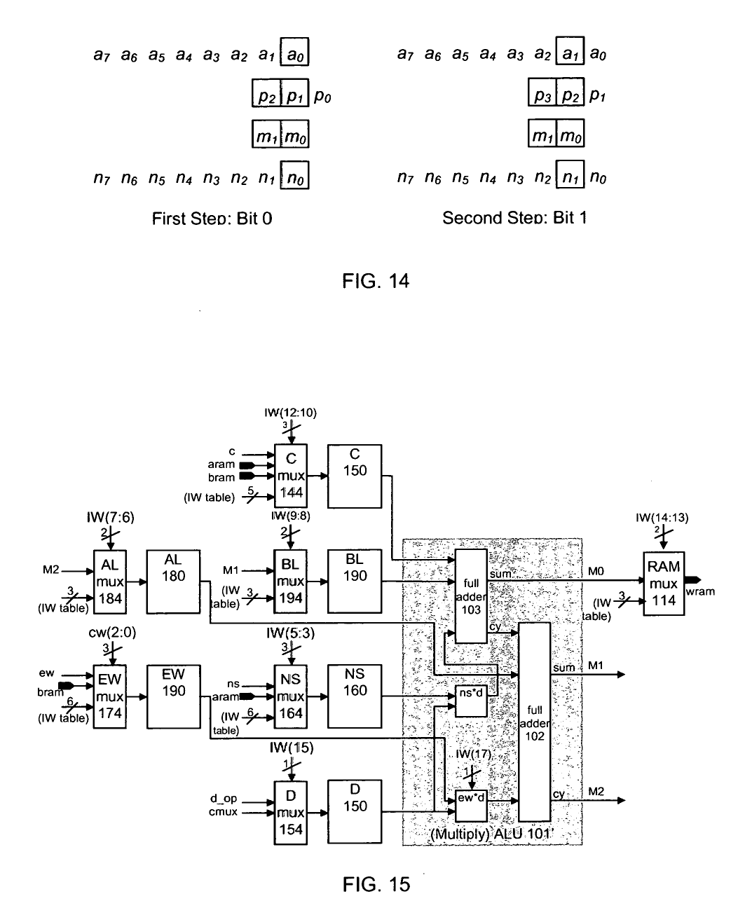

The improved multiply method may be illustrated by an example of a multiply of two 8-bit operands. (The first two cycles for the first pass are illustrated in FIG. 14.) The first two multiplier bits, m₁ and m₀ are loaded to the multiplier registers. The multiplier bits will remain unchanged throughout the first pass. For the first cycle, the multiplicand bit n₀ is loaded to the multiplicand register, the accumulator bit a₀ is loaded to the accumulator register, and the partial product registers are cleared. For each cycle of the multiply, the multiplier bits are multiplied by the multiplicand bit and the 2-bit result is added to the 2-bit partial product and the 1-bit accumulator to produce a 3-bit partial product result. The lowest p Bw_cy artial product bit (p₀ for the first cycle) is stored to memory and the next two partial product bits loaded to the partial product registers for the next cycle.

The second cycle is similar to the first except that the second bits of the accumulator and multiplicand (a₁ and n₁) are loaded, and instead of 0's the partial product registers contain a partial product from the previous multiply cycle. On each succeeding cycle, the least significant bit of the partial product is stored to the accumulator image.

For the first pass, p₀ is stored as a₀, p₁ is a₁ and so on. For the second pass, the accumulator image is accessed at a bit offset of 2 so that on the first cycle, a₂ is loaded (at the same time n₀ is loaded) and the p₀ value is written to a₂. The multiplier bits m₂ and m₃ are loaded to begin the second pass.

The deployment of PE registers to perform the improved multiply is shown in FIG. 15. The arrangement of PEs is intended to show that the D 150 register is used for the multiplicand bits, the EW 170 and NS 160 registers for multiplier bits, the AL 180 and BL 190 registers for the partial product bits, and the C 140 register for the accumulator bits. The Multiply ALU 101′ provides the multiplication and summing needed to produce the 3 partial product outputs. The PE signals representing the partial product bits are labeled M0, M1 and M2.

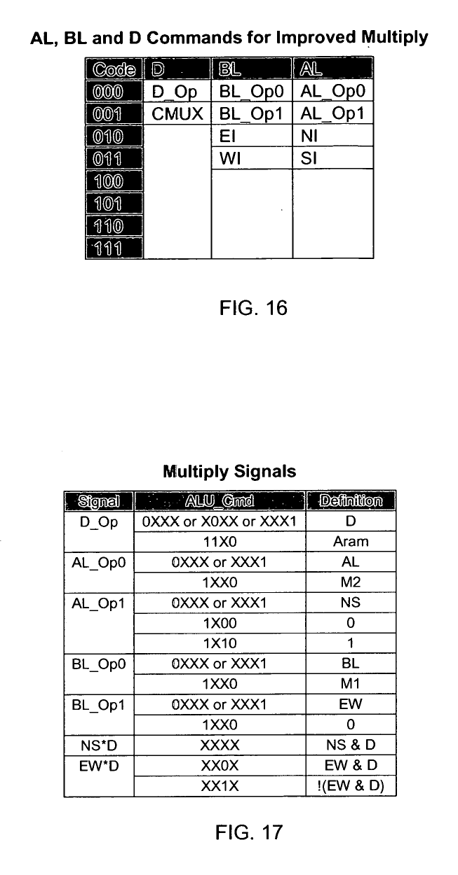

The redefinition of registers for the improved multiply is accommodated by the addition of signals to be selected by the AL, BL and D command fields of the PE instruction word (FIG. 16). These signals are labeled AL_Op0, AL_Op1, BL_Op0, BL_Op1, and D_Op and are defined as shown in FIG. 17. It may be seen that when the Alu_cmd is not 1XX0 (multiply mode), the AL, BL and D commands are defined for “normal” operation as shown in FIG. 9.

An Alu_cmd of 1XX0 causes the FIG. 17 signals to be defined for multiplication. AL_Op0 and BL_Op0 in particular couple the M2 and M1 ALU outputs to the AL 180 and BL 190 registers. Within the range of 1XX0, the Alu_cmd[1] and Alu_cmd[2] bits provide further controls needed for the improved multiply operation.

An active Alu_cmd[1] indicates an inversion of the high product bit (EW*D in the FIG. 17). This signal is activated during the final pass of a multiply where the multiplier is a signed image. An active Alu_cmd[1] also causes the AL register to be set to 1 instead of 0 during the first cycle of the final pass. This is part of the 2's complement inversion of the partial product generated by the high multiplicand bit.

An active Alu_cmd[2] signal causes the Aram value to be coupled to D_Op so that it may be loaded to the D 150 register.

The bit serial nature of the PE allows multiply operations to be performed on any size source and destination operands. Source operands may be image or scalar operands, signed or unsigned. The realization of a multiply sequencer in logic may impose a number of constraints, for instance the limitation of Src2 (multiplicand) operands to non-scalar (image) operands, the limitation of Src2 and Dest operand sizes to 2 bits or greater, and a prohibition against overwriting a source operand with the Dest operand. One constraint that is imposed by the PE architecture itself is the limitation of the improved multiply to vertical operations (i.e. no skew).

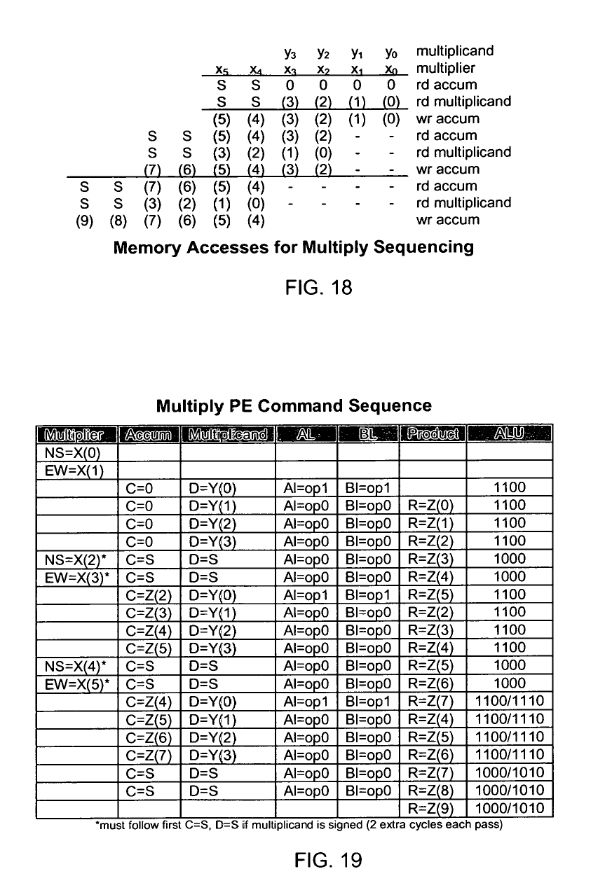

The method of sequencing the memory accesses for the multiply is shown in FIG. 18. In this example, a 6 bit Multiplier (x) multiplies a 4 bit Multiplicand (y). For each pass of the multiply, two Multiplier bits multiply the Multiplicand operand and add the partial product to the accumulator value. On the first pass, x₁x₀ multiplies y to produce a first accumulator value (5) . . . (0). On the second pass, x₃x₂ multiplies y and the 6-bit product is added to the accumulator bits (5) . . . (2) to produce the next accumulator (7) . . . (2). Note that the low accumulator bits (1) . . .(0) are not changed after the first pass. For the third pass, x₅x₄ multiplies y and the 6-bit product is added to the accumulator bits (7) . . . (4) to produce the final product bits (9) . . . (4). The accumulator bits (3) . . . (0) are not affected by this pass.

The pattern of PE Ram accesses for this operation is shown by FIG. 18. For each pass, 2 multiplier bits are loaded. The pass consists of the sequential load of multiplicand and accumulator bits and the store of the resulting new accumulator bits. For each pass, the multiplicand image is traversed from lsb to msb. However, the accumulator image is accessed (both load and store) at a starting point that is 2 bits higher for each pass. The accumulator also increases in size by 2 bits for each pass so that the number of writes to the accumulator is the same for every pass.

The multiply operation illustrated in FIG. 18 is implemented by the instruction sequence shown in FIG. 19. For each pass, 2 multiplier bits are loaded to NS 160 and EW 170. Next, the multiplicand bits are sequentially loaded to the D 150 register and accumulator bits (Z) are sequentially loaded to the C 140 register. After all multiplicand bits have been read, an additional 2 cycles must be performed to complete the generation of the new accumulator value for that pass. During these two cycles, the (old) accumulator value and multiplicand are sign extended in C and D. Also during these two cycles, the NS 160 and EW 170 registers are loaded in preparation for the next pass. (This concurrency is only possible if the multiplicand is unsigned since a non-zero D value will cause the ahead-of-time NS and EW values to interfere with the final accumulator values for each pass.) The ALU_Cmd follows a similar pattern, being set to 1100 during the first 4 cycles of each pass and 1000 during the 2 sign extension cycles. The AL 180 and BL 190 registers load 0 during the first cycle of each pass (al_op1, bl_op1) and M1/M2 during the remaining cycles (al_op0, bl_op0). The Wram write command is 1 throughout the multiply, storing the M0 value. During the first pass, the C 140 register is loaded with 0, since the accumulator is initially 0. The last pass is the same as a normal pass if the image is unsigned. For a signed multiplier image, however, the “invert” bit is set (ALU_Cmd=XX1X) during the last pass.

1. A processing array comprising a plurality of processing elements, wherein
a. each of the processing elements performs the same operation simultaneously in response to an instruction that is provided to all processing elements;
b. each processing element is configured to perform arithmetic operations on m-bit data values, propagating one of a carry and borrow results from each operation, and accepting a signal comprising one of a carry and borrow input to the operation;
c. the selection of the carry and borrow values to propagate is performed individually for each processing element by a mask value local to that processing element.

2. The processing array of claim 1, adapted to accomplish an operation on M-bit operands by performing M/m iterations of an m-bit operation.

3. The processing array of claim 1, wherein m is chosen as 1.

4. The processing array of claim 1, adapted to perform an Addsub operation consisting of setting the mask value to 0 for addition and setting the mask value to 1 for subtraction.

5. The processing array of claim 4, adapted to compute an absolute value by setting said mask to the value of the sign of a source operand and performing an Addsub of the source operand with 0.

6. The processing array of claim 4, adapted to perform one step of a sum of absolute differences by setting said mask to the value of the sign of the difference between two data values and then performing an Addsub of said difference with the sum.

7. The processing array of claim 4, adapted to perform one pass of a division operation by setting said mask to the value of the sign of a remainder and performing an Addsub of the denominator with the remainder.

8. The processing array of claim 4, adapted to perform one pass of a modulus operation by setting said mask to the value of the sign of a remainder and performing an Addsub of the denominator with the remainder.

9. A processing array comprising a plurality of processing elements, wherein
a. each of the processing elements performs the same operation simultaneously in response to an instruction that is provided to all processing elements;
b. the processing elements are interconnected to form a 2-dimensional mesh wherein each processing element is coupled to its 4 nearest neighbors to the north, south, east and west;
c. each processing element provides an NS register configured to hold data and to convey the data to the north neighbor while receiving data from the south neighbor in response to an instruction specifying a north shift, and to convey the data to the south neighbor while receiving data from the north neighbor in response to an instruction specifying a south shift;
d. each processing element provides an EW register configured to hold data and to convey the data to the east neighbor while receiving data from the west neighbor in response to an instruction specifying an east shift, and to convey the data to the west neighbor while receiving data from the east neighbor in response to an instruction specifying a west shift;
e. a simultaneous shift of data in opposite directions along one of the east-west and north-south axes is performed by using the NS and EW registers respectively to convey and receive data in opposite directions.

10. The processing array of claim 9, wherein the NS register is adapted to perform a shift of certain data to one of the north and the south, and wherein the EW register is adapted to perform a simultaneous shift of other data in the opposite direction.

11. The processing array of claim 9, wherein the EW register is adapted to perform a shift of certain data to one of the east and the west and wherein the NS register is adapted to perform a simultaneous shift of other data in the opposite direction.

12. The processing array of claim 9, adapted to perform the simultaneous shift of data in opposite directions in response to an instruction.

13. The processing array of claim 10, adapted to perform the simultaneous shift of data in opposite directions in response to a registered configuration signal.

14. The processing array of claim 11, adapted to perform the simultaneous shift of data in opposite directions in response to a registered configuration signal.

15. The processing array of claim 10 wherein the simultaneous shift of data through the EW register is employed via the signal paths used for north-south shifting through the NS register.

16. The processing array of claim 11 wherein the simultaneous shift of data through the NS register is employed via the signal paths used for east-west shifting through the EW register.

17. The processing array of claim 9, adapted to employ the simultaneous shift of data in opposite directions to perform a butterfly shuffle operation.

18. A processing array comprising a plurality of processing elements, wherein
a. each processing element comprises means adapted to perform a multiply of an m-bit multiplier by an n-bit multiplicand within a single pass, said pass comprising n cycles, each cycle comprising a load of a multiplicand bit to a multiplicand register, a load of an accumulator bit to an accumulator register, generation of a partial product value, and the storage of a computed accumulator bit to a memory;
b. said partial product comprising m+1 bits, the least significant bit of which is conveyed as the computed accumulator bit, and the remaining m bits are stored in an m-bit partial product register;
c. said partial product being computed by summing the accumulator bit, the registered partial product, and the m-bit product of the multiplicand bit and an m-bit multiplier.

19. The processing array of claim 18, wherein multiplication by an m-bit multiplier is performed by performing a single pass with an initial accumulator value of 0.

20. The processing array of claim 18, wherein multiplication by an M-bit multiplier is performed in M/m passes, the m-bit multiplier for the first pass comprises the lowest m bits of the M-bit multiplier, the initial accumulator value is 0 and access to the accumulator begins at bit 0 for the first pass, and wherein for each subsequent pass
a. access to the accumulator value begins at an m bit offset from the initial access for the previous pass;
b. the m-bit multiplier is selected from the M-bit multiplier at an m-bit offset from the point of selection for the previous pass.

21. The processing array of claim 18, wherein m is 2.

22. The processing array of claim 18, further including means for clearing the registered partial product at the beginning of a pass.

23. The processing array of claim 18, adapted to perform multiplication of a signed multiplier by inverting the highest bit of the m-bit product.

24. The processing array of claim 20, adapted to perform multiplication by a signed multiplier by inverting the highest bit of each m-bit product during the final pass.

25. The processing array of claim 18, adapted to perform m additional cycles, following said n cycles, during which said multiplicand bit is the multiplicand sign bit and said accumulator bit is the accumulator sign bit.

26. The processing array of claim 20, adapted to perform m additional cycles, following said n cycles, during which said multiplicand bit is the multiplicand sign bit and said accumulator bit is the accumulator sign bit.

27. The processing array of claim 26, adapted to represent said multiplicand and said accumulator sign bits by 0's for an unsigned multiplicand.

28. The processing array of claim 27, adapted to perform the load of the m multiplier bits for the next pass for an unsigned multiplicand, during said m cycles.
